(19) United States
(12) Patent Application Publication
(10) Pub. No.: US 2013/0341973 A1
(43) Pub. Date: Dec. 26, 2013

(54) TWO-WAY INTERLOCK SLIDING SYSTEM AND ROLLER BLIND APPARATUS HAVNIG THE SAME

(71) Applicant: Webasto Donghee Co., Ltd., Ulsan (KR)

(72) Inventors: Su-Yun Choi, Ulsan (KR); Jong-Rak Kim, Ulsan (KR); Seong-Min Gwak, Ulsan (KR); Chang-Min Park, Busan (KR)

(73) Assignee: WEBASTO DONGHEE CO., LTD., Ulsan (KR)

(21) Appl. No.: 13/895,009

(22) Filed: May 15, 2013

(30) Foreign Application Priority Data
Jun. 21, 2012 (KR) 10-2012-0066647

(51) Int. Cl. B60J 7/00

(52) U.S. Cl. CPC B60J 7/0015
USPC 296/219; 296/216.08

(57) ABSTRACT

A two-way interlock sliding system and a roller blind apparatus having the system, which has a power transmission unit causing two drive units to interlock-slide using one motor, thereby realizing a simple construction of the apparatus. The roller blind apparatus includes a front roller blind provided in a sunroof of a vehicle, a rear roller blind interlocked with the front roller blind so as to be opened or closed simultaneously with the front roller blind; a drive means generating drive power; a moving glass operated in conjunction with opening or closing motions of the two roller blinds; a power transmission unit for transmitting the power of the drive means such that the moving glass can be operated in conjunction with the opening or closing motions of the two roller blinds; and a control unit for controlling the drive means so as to control operations of the two roller blinds.

### CROSS-REFERENCE TO RELATED APPLICATIONS

This application claims priority to Korean Patent Application No. 10-2012-0066647 filed on 21.06.2012, which is incorporated herein by reference.

### TECHNICAL FIELD

The present invention relates, in general, to two-way interlock sliding systems and roller blind apparatuses having the systems and, more particularly, to a two-way interlock sliding system and a roller blind apparatus having the system, in which a power transmission unit is provided to cause two drive units to interlock-slide using one motor, thereby realizing a simple construction of the apparatus.

### RELATED ART

For many years, to allow passengers of vehicles to feel open and free, opening sunroofs that can be selectively opened and closed have been installed in the roofs of vehicles. Among more recent opening sunroofs, a panoramic sunroof in which a sunroof panel is completely formed by a glass structure has particularly impressed customers, and a trend has emerged where an increasing number of customers desire to own vehicles provided with such a sunroof.

The panoramic sunroof is formed by a glass structure and so the sunlight may shine directly into the passenger compartment through the glass sunroof. Accordingly, to appropriately brighten the passenger compartment while preventing sunlight from entering into the passenger compartment, a folding roller blind that is selectively opened or closed is typically installed together with the panoramic sunroof.

In the related art, to allow easy full opening and easy partial opening of the sunroof, the roller blind typically comprises a front roller blind and a rear roller blind. Further, the related art panoramic sunroof includes a moving glass in the front and a fixed glass in the rear. The moving glass performs an opening/closing motion and a tilting motion, while the fixed glass is fixed in a closed state.

In the related art, in addition to a drive motor for the moving glass, another drive motor for the roller blind is provided, so that the moving glass and the roller blind are operated by respective drive motors. In other words, to use a motored roller blind structure in the panoramic sunroof, two motors are required.

As described above, because respective drive motors should be installed in the panoramic sunroof so as to operate the roller blind and the moving glass in the related art, a technique capable of improving the related art structure is required.

As an example of related art techniques, Korean Patent Laid-open Publication No. 10-2012-0014615 (Patent Document 1) discloses an interlock type roll blind apparatus of a panoramic sunroof, which is configured such that a blind can be opened in conjunction with an opening motion of a sunroof glass, and such that the blind is not closed when the sunroof glass is in an open state.

The technique of the roll blind apparatus disclosed in the Patent Document 1 is a technique that can be used in a manually-operated blind apparatus and in which the blind can be opened in conjunction with an opening motion of the sunroof glass. However, to close the blind in the related art roll blind apparatus, a user should manually pull a handle upper after closing the sunroof glass so as to remove an interference of a slider, and when the user pulls the handle upper, the blind closes by an unfolding motion of the blind. Accordingly, the technique of the related art roll blind apparatus is problematic in that it causes inconvenience to a user and cannot be applied to a motored roller blind.

### SUMMARY

Accordingly, the present invention has been made keeping in mind the above problems occurring in the related art, and the present invention is intended to propose a roller blind apparatus which is configured such that the opening/closing operations of both a roller blind and a sunroof glass of a motored roller blind apparatus can be performed in conjunction with each other using one motor, thereby realizing a simple construction, improving price and market competitiveness, and providing more convenience to a user.

Further, the present invention is intended to propose a two-way interlock sliding system which is provided with a power transmission unit that can allow two drive units to perform interlock sliding motions using one motor.

In order to achieve the above objects, according to one aspect of the present invention, there is provided a two-way interlock sliding system, including: a first drive unit sliding in opposite directions by a drive means; a second drive unit sliding in conjunction with a sliding motion of the first drive unit; a guide rail for guiding sliding motions of the first and second drive units; and a power transmission unit for transmitting power of the drive means such that the second drive unit can slide in conjunction with the sliding motion of the first drive unit, wherein the power transmission unit includes: a first overmold mounted to the first drive unit and sliding inside the guide rail by the power of the drive means; a winding guide mounted to an upper surface of the guide rail; a guide lever configured such that, when the first overmold slides and reaches a position of the winding guide in a state in which the guide lever is inserted into the winding guide, the guide lever is rotated around a hinge provided in a first end thereof and is engaged with the first overmold, thereby sliding inside the guide rail; and a second overmold mounted to the second drive unit, with the guide lever being hinged to an end of the second overmold, so that, when the guide lever slides in a state in which the guide lever is engaged with the first overmold, the second overmold moves the second drive unit.

In the present invention, the first overmold may be provided with an insert part that protrudes so as to be inserted into a lower surface of the guide lever, the guide lever may be provided in the lower surface thereof with a holding part into which the insert part can be inserted, with a hook part being provided in a second end of the guide lever so that the hook part can be inserted into the winding guide, and the winding guide may be provided in a lower surface thereof with a hooking groove into which the hook part can be inserted.

Here, the hook part may include: an upper surface inclined downward in a direction toward the hinged end of the guide lever; and a lower surface inclined downward in a state in which the lower surface forms an acute angle with the upper surface of the hook part.

The present invention may further include: a control hook moving along with the first overmold to a stop position of the first drive unit, thereby aiding an opening motion of the first drive unit.

The present invention may further include: a stopper mounted to the second overmold and configured such that, when the guide lever is inserted into the winding guide, the stopper is rotated by a tensile force and supports a lower part of the guide lever, thereby preventing a downward movement of the guide lever.

In order to achieve the above objects, according to another aspect of the present invention, there is provided a roller blind apparatus, including: a front roller blind provided in a front section of a sunroof that is installed in a vehicle roof panel, so that the front roller blind can be opened or closed by a manipulation of a user; a rear roller blind interlocked with an operation of the front roller blind so that the rear roller blind can be opened or closed simultaneously with the front roller blind; a drive means generating drive power for opening or closing the front and rear roller blinds; a moving glass to which the power of the drive means is transmitted so that the moving glass can be operated in conjunction with opening or closing motions of the front and rear roller blinds; a power transmission unit for transmitting the power of the drive means such that the moving glass can be operated in conjunction with the opening or closing motions of the front and rear roller blinds; and a control unit for controlling an operation of the drive means so as to control operations of the front and rear roller blinds.

Here, the power transmission unit may be configured such that the moving glass can be opened after the opening motions of the front and rear roller blinds have been completed, and such that the closing motions of the front and rear roller blinds can be performed in conjunction with a closing motion of the moving glass.

In the present invention, the power transmission unit may include: a front blind overmold connected to a first cable actuated by the drive means so that the front blind overmold can slide inside a guide rail by the power of the drive means; a winding guide mounted to the guide rail at a predetermined location at which the front roller blind is opened; a guide lever configured such that, when the front blind overmold slides and reaches a position of the winding guide in a state in which the guide lever is inserted into the winding guide, the guide lever is rotated around a hinge provided in a first end thereof and is engaged with the front blind overmold, thereby sliding inside the guide rail; and a mechanism overmold mounted to a glass mechanism of the moving glass, with the guide lever being hinged to an end of the mechanism overmold, so that, when the guide lever slides in a state in which the guide lever is engaged with the front blind overmold, the mechanism overmold moves the moving glass, wherein the power of the drive means is transmitted such that, when the guide lever slides along the guide rail in a state in which the guide lever is engaged with the front blind overmold, the moving glass can be moved.

The drive means may include: a drive motor generating the drive power for opening or closing the front and rear roller blinds; a first cable connected to the drive motor at a first end thereof and connected to the front roller blind at a second end thereof; and a second cable connected to the drive motor at a first end thereof and connected to the rear roller blind at a second end thereof.

Further, the power transmission unit may be provided on each of guide rails that are placed in opposite sides of the vehicle roof panel.

As described above, in the present invention, to cause two drive units to slide, the power transmission is provided so as to drive the second drive unit by transmitting the power of the first drive unit to the second drive unit, and so the present invention is advantageous in that the two drive units can interlock-slide using one motor, thereby realizing a simple construction of the apparatus.

Further, the two-way interlock sliding system of the present invention is used in a panoramic sunroof, and so the on/off motions of both the front roller blind and the rear roller blind can be performed using one motor, and the moving glass can be operated in conjunction with the on/off motions of the front and rear roller blinds, so the present invention is advantageous in that it can reduce the number of motors, can realize a simple construction of the apparatus, and can reduce the production cost.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a sectional view illustrating the construction of a two-way interlock sliding system of the present invention, in which a first drive unit is being opened;

FIG. 2 is a sectional view illustrating the construction of the two-way interlock sliding system of the present invention, in which power is being transmitted from the first drive unit to a second drive unit;

FIG. 3 is a perspective view illustrating the construction of a roller blind apparatus of the present invention;

FIG. 4 is a perspective view illustrating a power transmission unit of the roller blind apparatus of the present invention;

FIG. 5A is an enlarged perspective view illustrating an important part of the power transmission unit of the present invention;

FIG. 5B is an enlarged sectional view illustrating an important part of the power transmission unit of the present invention;

FIG. 6 is an enlarged perspective view illustrating an important part of the roller blind apparatus of the present invention when a roller blind is being initially opened;

FIG. 7 is a perspective view illustrating a state in which the roller blind of the roller blind apparatus according to the present invention is being opened;

FIG. 8 is a perspective view illustrating a state in which power is being transmitted in the roller blind apparatus of the present invention;

FIGS. 9A and 9B are sectional views illustrating a state in which power is being transmitted in the roller blind apparatus of the present invention;

FIG. 10 is a perspective view illustrating a state in which a sunroof glass is being opened in the roller blind apparatus of the present invention;

FIGS. 11A and 11B are sectional views illustrating a state in which the sunroof glass is being closed in the roller blind apparatus of the present invention;

FIGS. 12A and 12B are bottom plane views illustrating the state in which the sunroof glass is being closed in the roller blind apparatus of the present invention; and

FIG. 13 is a perspective view illustrating the state in which the sunroof glass is being closed in the roller blind apparatus of the present invention.

### DETAILED DESCRIPTION

Hereinbelow, preferred embodiments of a two-way interlock sliding system and a roller blind apparatus having the system according to the present invention will be described in detail with reference to the accompanying drawings. However, it should be understood that the present invention is not limited to the preferred embodiments described hereinbelow, but may be embodied in the form of various configurations and that the preferred embodiments are intended merely to aid in the understanding of the present invention and to appropriately inform those skilled in the art of the scope of the present invention.

### First Embodiment

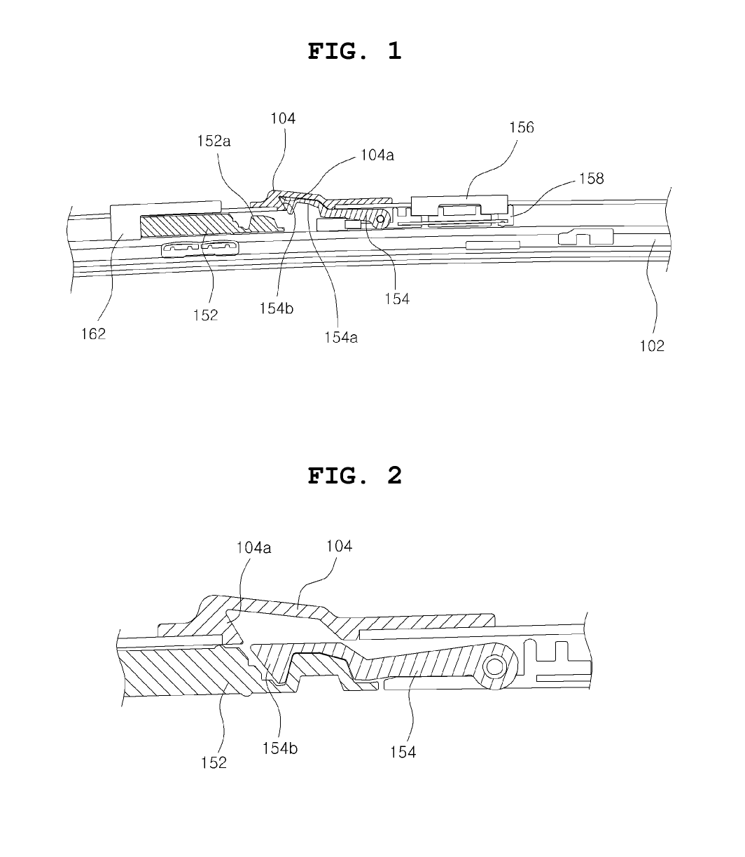

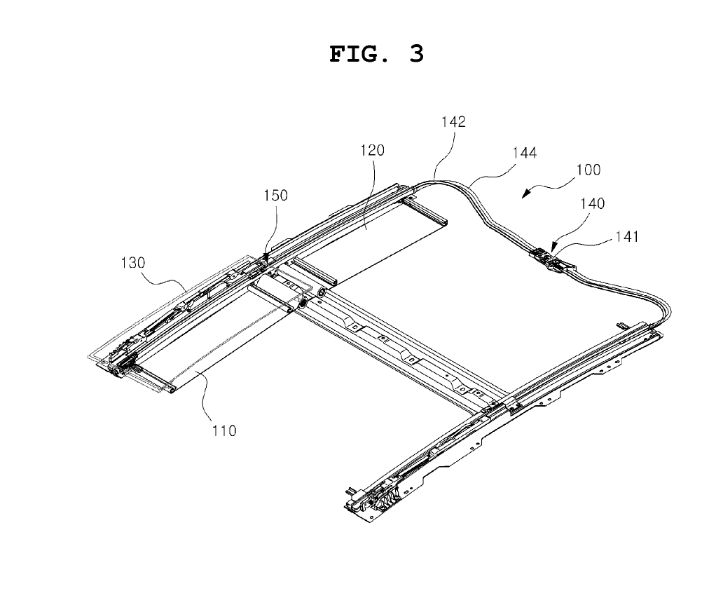

FIG. 1 is a sectional view illustrating the construction of a two-way interlock sliding system of the present invention, in which a first drive unit is being opened. FIG. 2 is a sectional view illustrating the construction of the two-way interlock sliding system of the present invention, in which power is being transmitted from the first drive unit to a second drive unit.

The two-way interlock sliding system of the present invention is a system that can cause two drive units to interlock-slide using one motor. The two-way interlock sliding system of the present invention includes a first drive unit (not shown) that can slide in opposite directions by a drive means which will be described later herein, a second drive unit (not shown) that is operated in conjunction with a sliding motion of the first drive unit, a guide rail 102 that can guide the sliding motions of the first and second drive units, and a power transmission unit that can transmit power of the drive means so as to cause the second drive unit to be operated in conjunction with the sliding motion of the first drive unit.

In FIGS. 1 and 2, neither the first drive unit nor the second drive unit is shown. However, it should be understood that both the first drive unit and the second drive unit may be freely selected from any devices or from any components if the devices or the components can slide along the guide rail 102 that will be described later herein.

Described in detail, the first drive unit is fixed to a first overmold 152 that can slide inside the guide rail 102, and the second drive unit is fixed to a second overmold 158 that can slide inside the guide rail 102.

In the present invention, the first drive unit and the second drive unit are not limited to specified units. That is, as described above, the first drive unit and the second drive unit may be freely selected from any devices or from any components if the devices or the components can slide along the guide rail 102. Because the first drive unit and the second drive unit are not limited to specified units in the present invention, a variety of devices or mechanical components may be used as the first and second drive units.

The power transmission unit of the present invention is configured such that, when the first drive unit completes a sliding motion in a direction (a rightward direction in FIGS. 1 and 2), the power transmission unit transmits power to the second drive unit so as to cause the second drive unit to slide in the same direction. To realize interlock sliding motions of the two drive units in an opposite direction, the power transmission unit transmits power such that, in conjunction with a sliding motion of the second drive unit in the opposite direction, the first drive unit can slide in the same direction.

To this end, the power transmission unit of the present invention includes the first overmold 152 that is fixed to the first drive unit and can slide inside the guide rail 102 by the power of the drive means, a winding guide 104 that is mounted to an upper surface of the guide rail 102, a guide lever 154 that can be inserted into or removed from the winding guide 104, and the second overmold 158 that is fixed to the second drive unit and can slide inside the guide rail 102.

The first overmold 152 is configured such that it can be inserted into the guide rail 102 in a state in which it is fixed to the first drive unit, and can slide in opposite directions. Further, the first overmold 152 may move by being connected to a cable (not shown) that is connected to the drive means.

Here, the drive means may be a reversible drive motor that can rotate in a forward direction or in a backward direction.

When the first overmold 152 is connected to the cable, the first overmold 152 can slide in one of opposite directions inside the guide rail 102 according to a rotating direction of the drive motor.

The winding guide 104 is mounted to the guide rail 102 and is provided in a lower surface thereof with a hooking groove 104a into which the guide lever 154 is inserted.

Further, the guide lever 154 is provided on an end opposite to a hinged end thereof with a hook part 154b that can be inserted into the hooking groove 104a of the winding guide 104.

Here, it is preferred that both the hook part 154b and the hooking groove 104a be configured to have shapes corresponding to each other.

One end of the guide lever 154 is hinged to the second overmold 158. The hook part 154b of the present invention includes an upper surface that is inclined downward in a direction toward the hinged end, and a lower surface that is configured to form an acute angle with the upper surface and is inclined downward.

Further, the first overmold 152 is provided with an insert part 152a that protrudes so as to be inserted into the lower surface of the guide lever 154. The lower surface of the guide lever 154 is provided with a holding part 154a into which the insert part 152a is inserted.

Further, a control hook 162 is installed on the first overmold 152 so that the control hook 162 moves along with the first overmold 152 to a stop position of the first drive unit, thereby aiding the opening motion of the first drive unit.

In the present invention, a stopper (not shown) is fixed to the second overmold 158. When the guide lever 154 is removed from the winding guide 104, the stopper moves to an edge and transmits power to the second overmold 158.

Further, when the guide lever 154 is inserted into the winding guide 104, the stopper rotates by a tensile force and supports the lower part of the guide lever 154, thereby preventing the guide lever 154 from being unexpectedly moved downward from the winding guide 104. Therefore, the stopper maintains the inserted state of the guide lever 154 in the winding guide 104.

The operation of the two-way interlock sliding system according to the present invention having the above-mentioned construction will be described hereinbelow.

First, the first overmold 152 slides inside the guide rail 102 by the power of the drive means.

Here, the first overmold 152 moves to the right in the drawings.

In the above state, the control hook 162 that is mounted to the outer surface of the guide rail 102 moves along with the first overmold 152 to the stop position of the first drive unit, thereby aiding the sliding motion of the first drive unit.

When the sliding motion of the first drive unit is completed, the power transmission unit transmits the power of the drive means to the second drive unit.

That is, as shown in FIG. 2, when the first overmold 152 slides and reaches the winding guide 104, the first overmold 152 comes into contact with the second overmold 158, and so the first overmold 152 and the second overmold 158 slide at the same time.

In the above state, when the second overmold 158 slides, the guide lever 154 that is hinged to the second overmold 158 slides. Here, the guide lever 154 performs a rotating motion together with the sliding motion, so that the guide lever 154 is removed from the winding guide 104 and is engaged with the first overmold 152.

Here, the first overmold 152 is provided with the insert part 152a that protrudes so as to be inserted into the lower surface of the guide lever 154. Further, the lower surface of the guide lever 154 is provided with the holding part 154a into which the insert part 152a can be inserted. Accordingly, due to the engagement of the insert part 152a with the holding part 154a, the guide lever 154 that is combined with the first overmold 152 can slide along the guide rail 102.

When the first overmold 152 further slides, the guide lever 154 that is combined with the first overmold 152 slides, and the second overmold 158 that is combined with the guide lever 154 also slides, so that the second drive unit to which the second overmold 158 is fixed can slide.

On the other hand, a sliding operation in an opposite direction will be performed as follows.

When the drive means rotates in a backward direction, the first overmold 152 slides to the left in the drawings and reaches the winding guide 104. When the first overmold 152 reaches the winding guide 104, the guide lever 154 is rotated and is inserted into the hooking groove 104a of the winding guide 104.

Here, the hook part 154b of the guide lever 154 is inserted into the hooking groove 104a, so that the guide lever 154 cannot further slide, but the first overmold 152 moves in a state in which the first overmold 152 is removed from the guide lever 154.

Further, the stopper is rotated by a tensile force and prevents an unexpected downward movement of the guide lever 154, thereby maintaining the inserted state of the guide lever 154 in the hooking groove 104a of the winding guide 104.

### Second Embodiment

The second embodiment of the present invention is intended to adapt the above-mentioned two-way interlock sliding system of the present invention to both a motored roller blind and a moving glass of a panoramic sunroof.

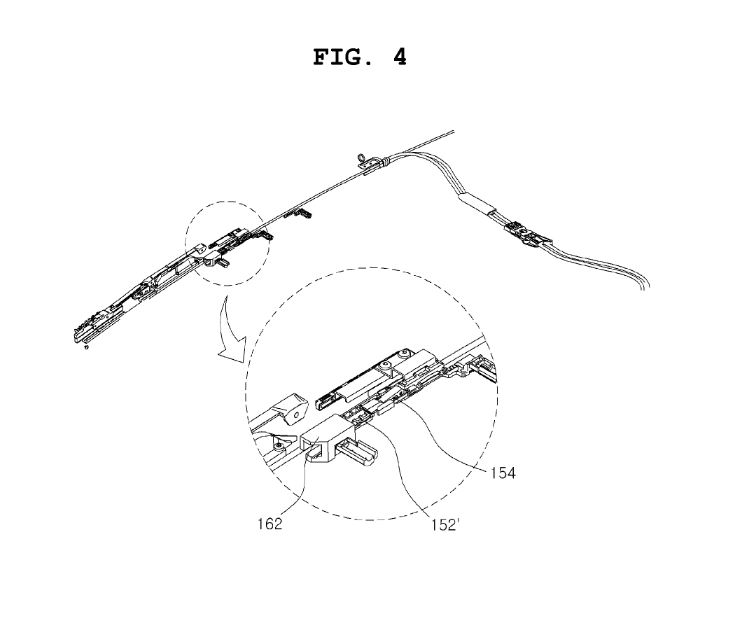

FIG. 3 is a perspective view illustrating the construction of the two-way interlock sliding system of the present invention and of the roller blind apparatus having the system.

As shown in FIG. 3, the two-way interlock sliding system and the roller blind apparatus 100 having the system according to the embodiment of the present invention includes a front roller blind 110, a rear roller blind 120, a drive means 140 that generates drive power for realizing opening/closing motions of both the front roller blind 110 and the rear roller blind 120, a moving glass 130 of the sunroof, a power transmission unit 150 that transmits the power so as to allow the moving glass 130 to be operated in conjunction with the opening/closing motions of both the front roller blind 110 and the rear roller blind 120, and a control unit (not shown) that controls the operation of the drive means 140.

The front roller blind 110 is provided in the front section of a sunroof that is installed in a vehicle roof panel, so that the front roller blind 110 can be manually opened or closed by a user. The roller blind apparatus 100 of the present invention is configured such that both the front roller blind 110 and the rear roller blind 120 can be opened or closed at the same time by the drive means 140.

To this end, the drive means 140 includes a drive motor 141 that generates drive power for realizing the opening/closing motions of both the front roller blind 110 and the rear roller blind 120, a first cable 142 that is connected to the drive motor 141 at a first end thereof and is connected to the front roller blind 110 at a second end, and a second cable 144 that is connected to the drive motor 141 at a first end thereof and is connected to the rear roller blind 120 at a second end.

When the drive motor 141 is operated and generates drive power, the first cable 142 pulls the front roller blind 110 in a direction toward the drive motor 141 and, at the same time, the second cable 144 pushes the rear roller blind 120, so that the two cables 142 and 144 can open both the front roller blind 110 and the rear roller blind 120 at the same time.

The operation for closing both the front roller blind 110 and the rear roller blind 120 is performed in an opposite direction. The construction and operation for opening or closing the front and rear roller blinds are well known to those skilled in the art and further explanation is thus deemed unnecessary and is omitted in the description.

Further, the structure for connecting the first cable 142 and the second cable 144 to the front roller blind 110 and the rear roller blind 120, respectively, will be described later herein.

The roller blind apparatus 100 of the present invention is characterized in that the power of the drive means 140 is transmitted such that the moving glass 130 can be operated in conjunction with the opening/closing motions of the front roller blind 110 and the rear roller blind 120.

To this end, the power transmission unit 150 is provided to allow the moving glass 130 to be operated in conjunction with the opening/closing motions of the front roller blind 110 and the rear roller blind 120.

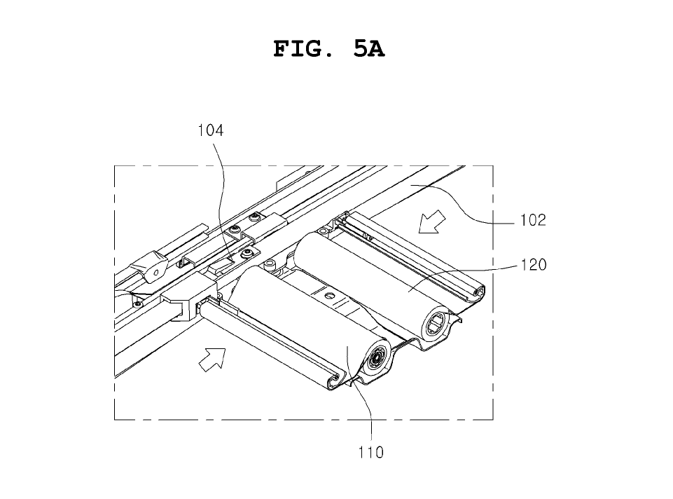

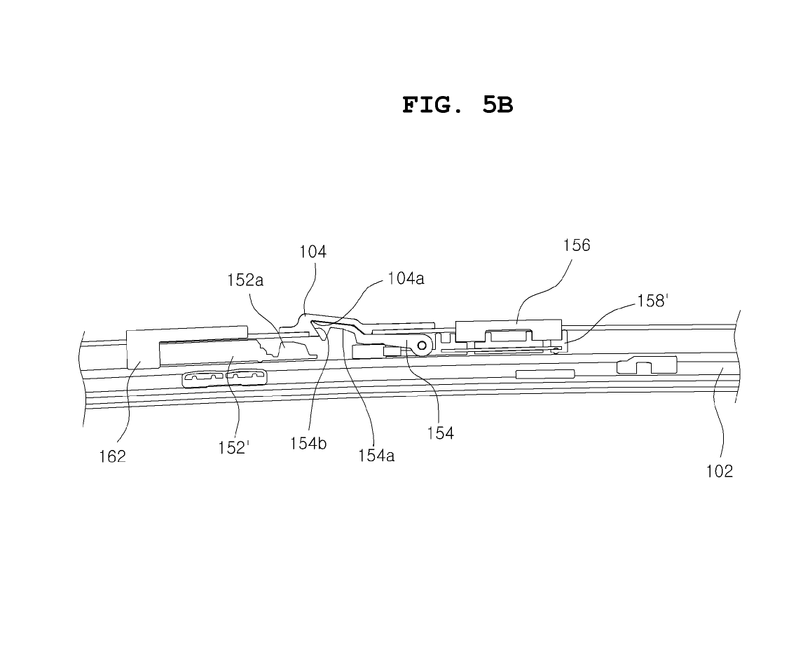

FIG. 4 is a perspective view illustrating the power transmission unit of the roller blind apparatus according to the present invention. FIG. 5A is an enlarged perspective view illustrating an important part of the power transmission unit of the present invention. FIG. 5B is an enlarged sectional view illustrating the power transmission unit of the present invention.

In the present invention, the power transmission unit 150 is configured such that the moving glass 130 can be opened after opening motions of both the front roller blind 110 and the rear roller blind 120 have been completed, and such that closing motions of both the front roller blind 110 and the rear roller blind 120 can be performed in conjunction with a closing motion of the moving glass 130.

Further, in the drawings, the power transmission unit 150 is shown as being provided on one side of a vehicle roof panel. However, it should be understood that the power transmission unit 150 may be provided on each of guide rails that are installed in opposite sides of the vehicle roof panel.

Described in detail, the power transmission unit 150 includes a front blind overmold 152′ that is connected to the first cable 142 and slides inside the guide rail 102 by the power of the drive motor 141, a winding guide 104 that is mounted to the guide rail 102, a guide lever 154 that is configured such that when the front blind overmold 152′ reaches the winding guide 104 in a state in which the guide lever 154 is inserted into the winding guide 104, the guide lever 154 is engaged with the front blind overmold 152′ and slides along the guide rail 102, and a mechanism overmold 158′ that is mounted to a glass mechanism 156 of the moving glass 130 and to one end of which the guide lever 154 is hinged, so that the mechanism overmold 158′ can move the moving glass 130 in response to a sliding motion of the guide lever 154.

The front blind overmold 152′ is connected to the first cable 142 and pulls or pushes the front roller blind 110. Here, a control hook 162 is installed on the front blind overmold 152′ so that the control hook 162 can move along with the front blind overmold 152′ to a stop position of the front roller blind 110, thereby aiding the opening motion of the front roller blind 110.

Further, a rear blind overmold that is connected to the second cable 144 is installed in the rear roller blind 120, so that when the front blind overmold 152′ slides in a direction by the power of the drive motor 141, the rear blind overmold can slide in an opposite direction so as to open or close the rear roller blind 120.

As shown in FIG. 5A, the winding guide 104 is mounted to the guide rail 102 at a predetermined location at which the front roller blind 110 is opened. A hooking groove 104a into which the guide lever 154 is inserted is formed in the lower surface of the winding guide 104.

The front blind overmold 152′ is provided with an insert part 152a that protrudes so as to be inserted into the lower surface of the guide lever 154. A holding part 154a into which the insert part 152a is inserted is provided in the lower surface of the guide lever 154.

Further, the guide lever 154 is provided in the upper end thereof with a hook part 154b that can be inserted into the hooking groove 104a of the winding guide 104.

Here, the hook part 154b and the hooking groove 104a are configured to have respective shapes corresponding to each other.

Here, the guide lever 154 is hinged at a first end (an end facing a direction in which the moving glass 130 is opened) to the mechanism overmold 158′. As shown in FIG. 5B, the hook part 154b of the present invention is configured such that a distal end thereof that is an end facing a direction in which the front roller blind 110 is closed forms an acute angle.

In other words, the shape of the hook part 154b is configured such that the hook part 154a forms an inclined surface facing a direction in which the moving glass 130 is opened and the distal end of the hook part 154a facing an opposite direction, that is, the distal end facing a direction in which the moving glass 130 is closed forms an acute angle.

The above-mentioned power transmission unit 150 of the present invention is configured such that, when the front blind overmold 152′ slides and reaches a location of the winding guide 104 in a state in which the guide lever 154 is inserted into the winding guide 104, the front blind overmold 152′ comes into contact with the mechanism overmold 158′ and both the front blind overmold 152′ and the mechanism overmold 158′ slide in a direction in which the front roller blind 110 is opened.

In the above state, in response to a sliding motion of the mechanism overmold 158′, the guide lever 154 in the drawings slides and is rotated counterclockwise in a state in which the guide lever 154 is inserted into the hooking groove 104a of the winding guide 104, so that the guide lever 154 is removed from the winding guide 104 and, at the same time, the guide lever 154 is engaged with the front blind overmold 152′.

Accordingly, when the front blind overmold 152′ further slides, the guide lever 154 that is engaged with the front blind overmold 152′ slides and the mechanism overmold 158′ to which the guide lever 154 is hinged slides along with the front blind overmold 152′.

Here, the mechanism overmold 158′ is mounted to the glass mechanism 156 of the moving glass 130 so that the moving glass 130 can be moved in response to the sliding motion of the mechanism overmold 158′, thereby being opened.

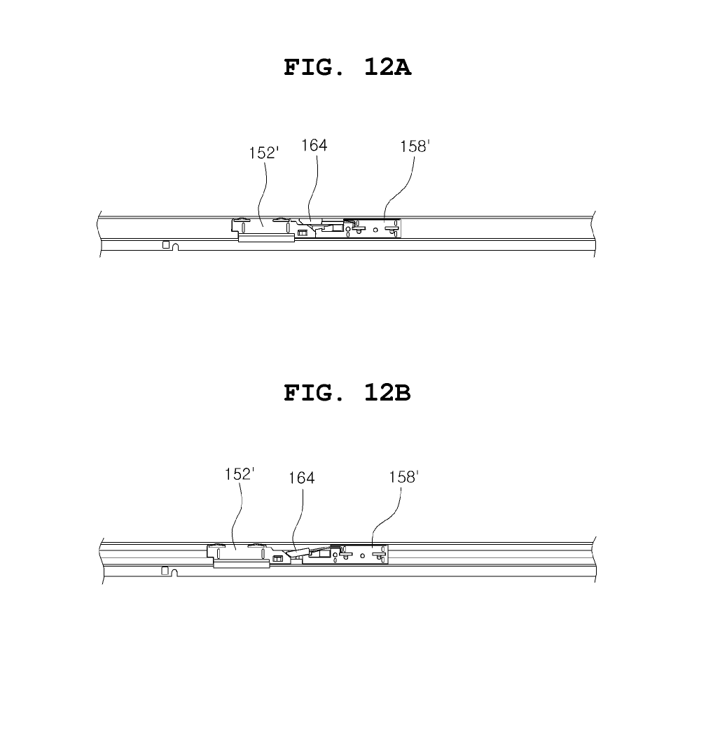

On the other hand, as shown in FIGS. 12A and 12B, the roller blind apparatus 100 of the present invention is provided with a stopper 164 that is mounted to the mechanism overmold 158′. In a state in which the guide lever 154 is removed from the winding guide 104, the stopper 164 moves to an edge as shown in FIG. 12A and transmits power to the mechanism overmold 158′.

Further, when the guide lever 154 is inserted into the winding guide 104, the stopper 164 is rotated by a tensile force as shown in FIG. 12B and supports the lower part of the guide lever 154, thereby preventing an unexpected downward movement of the guide lever 154. Accordingly, the stopper 164 can maintains the inserted state of the guide lever 154 in the winding guide 104.

The operation of the panoramic sunroof roller blind apparatus of the present invention having the above-mentioned construction will described hereinbelow.

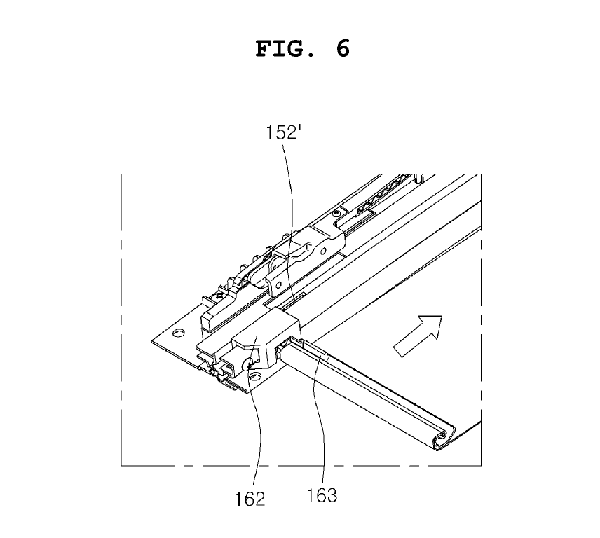

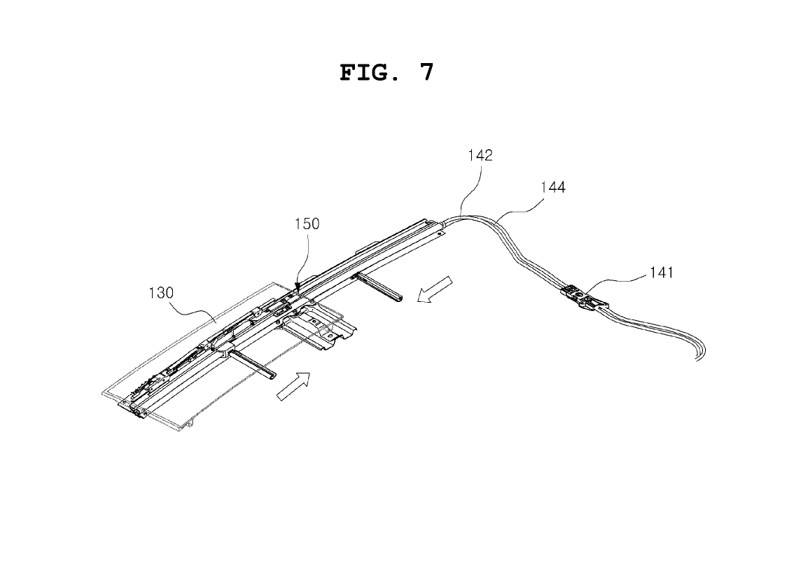

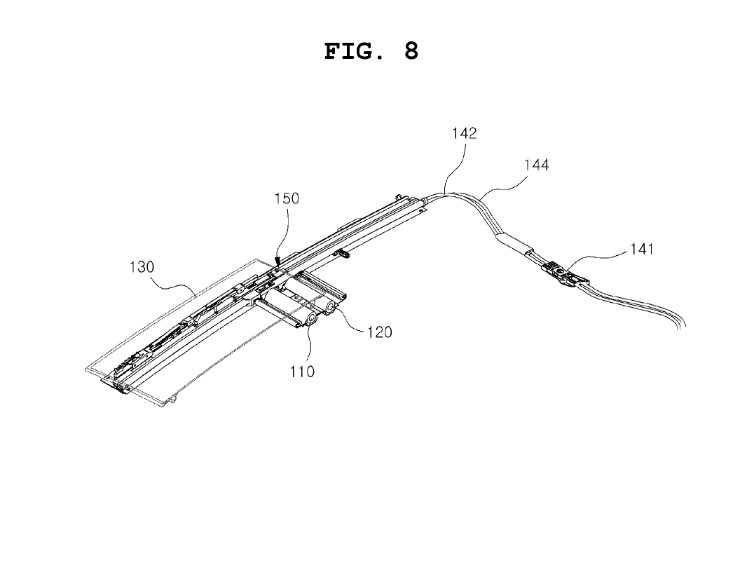

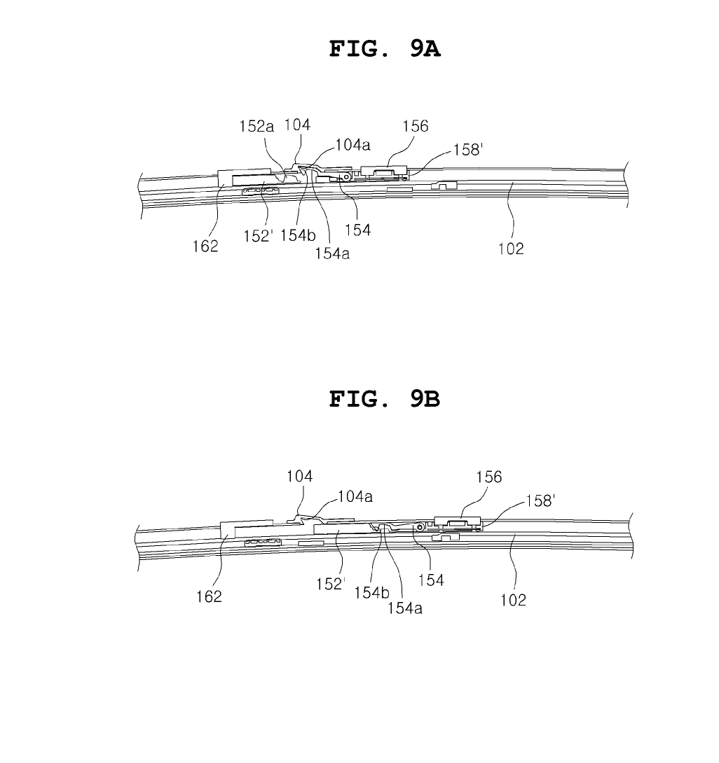

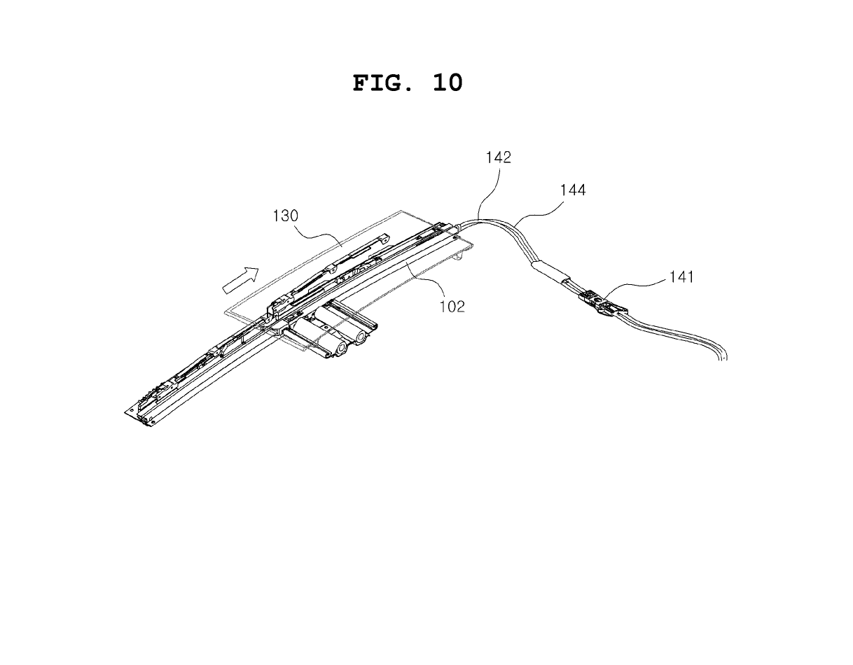

FIG. 6 is an enlarged perspective view illustrating an important part of the roller blind apparatus of the present invention when a roller blind is being initially opened. FIG. 7 is a perspective view illustrating a state in which the roller blind of the roller blind apparatus according to the present invention is being opened. FIG. 8 is a perspective view illustrating a state in which power is being transmitted in the roller blind apparatus of the present invention.

First, the front blind overmold 152′ that is connected to the first cable 142 is moved by the power of the drive motor 141.

In the above state, both the front roller blind 110 and the rear roller blind 120 are opened in conjunction with each other.

Further, the control hook 162 that is mounted to the outer surface of the guide rail 102 slides along with the front blind overmold 152′ to a stop position of the front roller blind 110 and aids an opening motion of the roller blind.

Thereafter, when both the front roller blind 110 and the rear roller blind 120 are completely opened, the power transmission unit 150 of the present invention transmits the power of the drive motor 141 to the moving glass 130.

That is, as shown in FIG. 8, when both the front roller blind 110 and the rear roller blind 120 are completely opened, the front blind overmold 152′ slides and reaches a location of the winding guide 104 and, in the above state, the front blind overmold 152′ comes into contact with the mechanism overmold 158′, so that both the front blind overmold 152′ and the mechanism overmold 158′ can slide at the same time.

Here, in response to the sliding motion of the mechanism overmold 158′, the guide lever 154 that is hinged to the mechanism overmold 158′ slides and is rotated so that the guide lever 154 is removed from the winding guide 104 and, at the same time, the guide lever 154 is engaged with the front blind overmold 152′ and slides along the guide rail 102.

Therefore, when the front blind overmold 152′ further slides, the guide lever 154 that is engaged with the front blind overmold 152′ also slides. In the above state, the mechanism overmold 158′ that is combined with the guide lever 154 is fixed to the glass mechanism 156 of the moving glass 130, so that the moving glass 130 can be moved.

Here, when the guide lever 154 is removed from the winding guide 104, the stopper 164 moves to an edge and transmits the power to the mechanism overmold 158′.

Accordingly, the moving glass 130 is connected to the drive motor 141 and can be opened, as shown in FIG. 8.

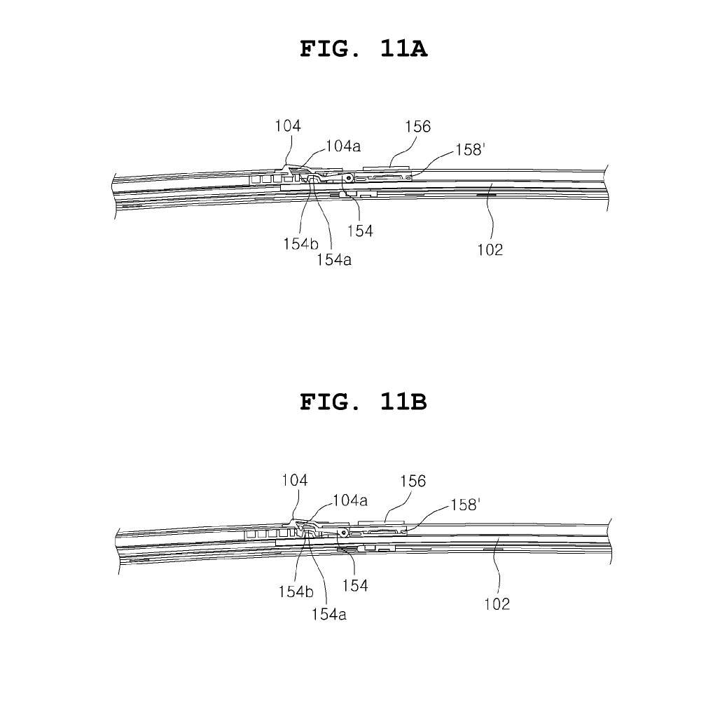

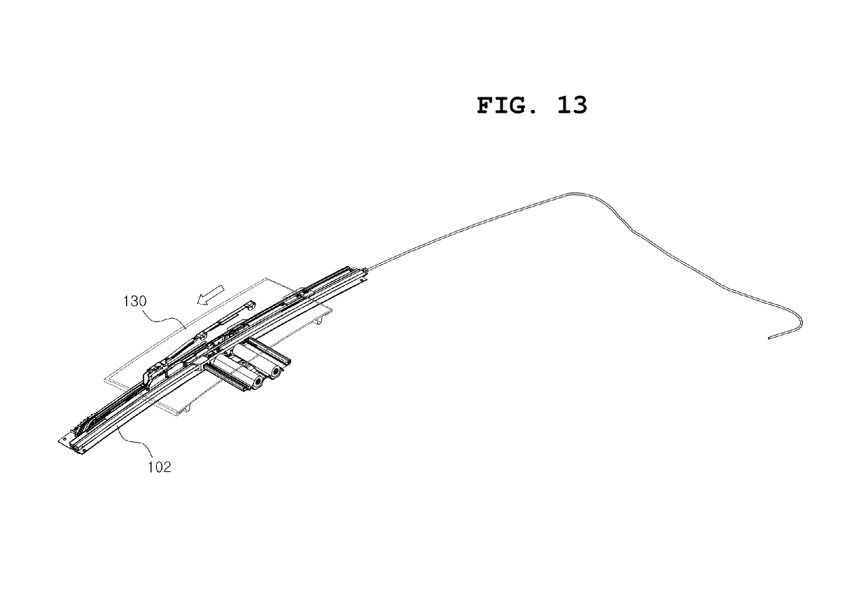

FIGS. 11A and 11B are sectional views illustrating a state in which the sunroof glass is being closed in the roller blind apparatus of the present invention. FIGS. 12A and 12B are bottom plane views illustrating the state in which the sunroof glass is being closed in the roller blind apparatus of the present invention. FIG. 13 is a perspective view illustrating the state in which the sunroof glass is being closed in the roller blind apparatus of the present invention.

The operation for closing the moving glass 130 is performed by transmitting the power of the drive motor 141 to the moving glass 130 due to an engagement of the front blind overmold 152′ with the guide lever 154, thereby closing the moving glass 130.

When the front blind overmold 152′ slides in a direction in which the moving glass 130 is closed, and reaches the location of the winding guide 104, the guide lever 154 is rotated and inserted into the hooking groove 104a of the winding guide 104.

Here, because the hook part 154b of the guide lever 154 is configured such that the hook part 154b forms an acute angle in a direction in which the front roller blind 110 is closed, the guide lever 154 that is engaged with the hooking groove 104a cannot further slide in the closing direction of the front roller blind 110 and the front roller blind 110 moves after being removed from the guide lever 154.

Further, the stopper 164 is rotated by a tensile force and prevents an unexpected downward movement of the guide lever 154, thereby maintaining an inserted state of the guide lever 154 in the hooking groove 104a of the winding guide 104.

Accordingly, both the front roller blind 110 and the rear roller blind 120 can be closed in conjunction with a closing motion of the moving glass 130.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A two-way interlock sliding system, comprising:
a first drive unit sliding in opposite directions by a drive means;
a second drive unit sliding in conjunction with a sliding motion of the first drive unit;
a guide rail for guiding sliding motions of the first and second drive units; and
a power transmission unit for transmitting power of the drive means such that the second drive unit can slide in conjunction with the sliding motion of the first drive unit,
wherein the power transmission unit comprises:
a first overmold mounted to the first drive unit and sliding inside the guide rail by the power of the drive means;
a winding guide mounted to an upper surface of the guide rail;
a guide lever configured such that, when the first overmold slides and reaches a position of the winding guide in a state in which the guide lever is inserted into the winding guide, the guide lever is rotated around a hinge provided in a first end thereof and is engaged with the first overmold, thereby sliding inside the guide rail; and
a second overmold mounted to the second drive unit, with the guide lever being hinged to an end of the second overmold, so that, when the guide lever slides in a state in which the guide lever is engaged with the first overmold, the second overmold moves the second drive unit.

2. The two-way interlock sliding system as set forth in claim 1, wherein
the first overmold is provided with an insert part that protrudes so as to be inserted into a lower surface of the guide lever;
the guide lever is provided in the lower surface thereof with a holding part into which the insert part can be inserted, with a hook part being provided in a second end of the guide lever so that the hook part can be inserted into the winding guide; and
the winding guide is provided in a lower surface thereof with a hooking groove into which the hook part can be inserted.

3. The two-way interlock sliding system as set forth in claim 2, wherein the hook part includes:
an upper surface inclined downward in a direction toward the hinged end of the guide lever; and
a lower surface inclined downward in a state in which the lower surface forms an acute angle with the upper surface of the hook part.

4. The two-way interlock sliding system as set forth in claim 1, further comprising:
a control hook moving along with the first overmold to a stop position of the first drive unit, thereby aiding an opening motion of the first drive unit.

5. The two-way interlock sliding system as set forth in claim 1, further comprising:
a stopper mounted to the second overmold and configured such that, when the guide lever is inserted into the winding guide, the stopper is rotated by a tensile force and supports a lower part of the guide lever, thereby preventing a downward movement of the guide lever.

6. A roller blind apparatus, comprising:
a front roller blind provided in a front section of a sunroof that is installed in a vehicle roof panel, so that the front roller blind can be opened or closed by a manipulation of a user;
a rear roller blind interlocked with an operation of the front roller blind so that the rear roller blind can be opened or closed simultaneously with the front roller blind;
a drive means generating drive power for opening or closing the front and rear roller blinds;
a moving glass to which the power of the drive means is transmitted so that the moving glass can be operated in conjunction with opening or closing motions of the front and rear roller blinds;
a power transmission unit for transmitting the power of the drive means such that the moving glass can be operated in conjunction with the opening or closing motions of the front and rear roller blinds; and
a control unit for controlling an operation of the drive means so as to control operations of the front and rear roller blinds.

7. The roller blind apparatus as set forth in claim 6, wherein the power transmission unit is configured such that the moving glass can be opened after the opening motions of the front and rear roller blinds have been completed, and such that the closing motions of the front and rear roller blinds can be performed in conjunction with a closing motion of the moving glass.

8. The roller blind apparatus as set forth in claim 6 or 7, wherein the power transmission unit comprises:
a front blind overmold connected to a first cable actuated by the drive means so that the front blind overmold can slide inside a guide rail by the power of the drive means;
a winding guide mounted to the guide rail at a predetermined location at which the front roller blind is opened;
a guide lever configured such that, when the front blind overmold slides and reaches a position of the winding guide in a state in which the guide lever is inserted into the winding guide, the guide lever is rotated around a hinge provided in a first end thereof and is engaged with the front blind overmold, thereby sliding inside the guide rail; and
a mechanism overmold mounted to a glass mechanism of the moving glass, with the guide lever being hinged to an end of the mechanism overmold, so that, when the guide lever slides in a state in which the guide lever is engaged with the front blind overmold, the mechanism overmold moves the moving glass,
wherein the power of the drive means is transmitted such that, when the guide lever slides along the guide rail in a state in which the guide lever is engaged with the front blind overmold, the moving glass can be moved.

9. The roller blind apparatus as set forth in claim 8, wherein
the front blind overmold is provided with an insert part that protrudes so as to be inserted into a lower surface of the guide lever;
the guide lever is provided in the lower surface thereof with a holding part into which the insert part can be inserted, with a hook part being provided in a second end of the guide lever so that the hook part can be inserted into the winding guide; and
the winding guide is provided in a lower surface thereof with a hooking groove into which the hook part can be inserted.

10. The roller blind apparatus as set forth in claim 9, wherein the hook part includes:
an upper surface inclined downward in a direction toward the hinged end of the guide lever; and
a lower surface inclined downward in a state in which the lower surface forms an acute angle with the upper surface of the hook part.

11. The roller blind apparatus as set forth in claim 8, further comprising:
a control hook moving along with the front blind overmold to a stop position of the front roller blind, thereby aiding an opening motion of the front roller blind.

12. The roller blind apparatus as set forth in claim 8, wherein further comprising:
a stopper mounted to the mechanism overmold and configured such that, when the guide lever is inserted into the winding guide, the stopper is rotated by a tensile force and supports a lower part of the guide lever, thereby preventing a downward movement of the guide lever.

13. The roller blind apparatus as set forth in claim 6, wherein the drive means comprises:
a drive motor generating the drive power for opening or closing the front and rear roller blinds;
a first cable connected to the drive motor at a first end thereof and connected to the front roller blind at a second end thereof; and
a second cable connected to the drive motor at a first end thereof and connected to the rear roller blind at a second end thereof.

14. The roller blind apparatus as set forth in claim 6, wherein the power transmission unit is provided on each of guide rails that are placed in opposite sides of the vehicle roof panel.
